(19) United States
(12) Patent Application Publication
(10) Pub. No.: US 2013/0339111 A1
(43) Pub. Date: Dec. 19, 2013

(54) ADVERTISEMENT INCENTIVIZED GAMES

(71) Applicants: Imanuel Ross, Twin Waters (AU); Lydia Ross, Twin Waters (AU)

(72) Inventors: Imanuel Ross, Twin Waters (AU); Lydia Ross, Twin Waters (AU)

(21) Appl. No.: 13/524,601

(22) Filed: Jun. 15, 2012

(51) Int. Cl. G06Q 30/02; G06F 17/00

(52) U.S. Cl. 705/14.12; 463/31; 463/25; 463/7; 463/9; 705/14.45; 705/14.71

(57) ABSTRACT

Disclosed are computer-implemented methods and systems for advertisement of products or services within electronic games, such as brain fitness games, games of skill, or development games. In general, these methods and systems enable incorporation of advertisement images or videos as a background and/or as a major subject of the electronic games. In an example, the method may comprise receiving a user request to initiate the electronic game for a user, providing a graphical interface of the electronic game, and providing, within the graphical interface, one or more graphical objects representing the product. The graphical objects may constitute at least one subject of the electronic game or be a background image or video.

### TECHNICAL FIELD

This disclosure relates generally to promotion of products within electronic game environments, and, more specifically, to computer-implemented methods and systems for advertisement of products, services or brands within various electronic games such as brain fitness games.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Computer games are a popular way of entertainment, however, they can also be used for instructional or teaching purposes, such as teaching or practicing certain skills. Some computer games are designed for simulation purposes, such as planning a strategy, controlling of a virtual vehicle, and so forth. Yet, still other computer games can be used simultaneously for multiple purposes, for example, to provide entertainment and practicing skills, or simulation and practicing skills, or so forth.

Traditionally, the computer game industry has incorporated advertisements or promotions of various products or services into computer games. The incorporation of advertisements helps game companies to increase revenue, decrease retail prices of the computer games, or even allow distribution of the computer games free of charge. Typical advertisements incorporated into computer games may be implemented as banners, images, videos, scrolling text or tickers, flashing objects, pop-up windows, and so forth.

There are several problems that may be caused by incorporation of advertisements into computer games such as, for example, distracting players from the play of the computer games. Furthermore, the advertisements incorporated into the computer games may significantly reduce the display area available for playing the game. As a result, advertisements placed within computer games are frequently ignored, generate low brand awareness, have low click-through rates, and, in general, have limited effectiveness.

### SUMMARY

This summary is provided to introduce a selection of concepts in a simplified form that are further described below in the Detailed Description. This summary is not intended to identify key features or essential features of the claimed subject matter, nor is it intended for use as an aid in determining the scope of the claimed subject matter.

The present disclosure relates to computer-implemented methods and systems for advertisement of products, services or brands within electronic games such as brain fitness games, games of skill, development games, and so forth. In general, these methods and systems enable incorporation of advertisement images or videos as a background and/or as a major feature of the electronic games.

Incorporation of advertisements within graphical interfaces of electronic games may enable decreasing retail prices of these games or even provide them free of charge. In various embodiments, the electronic games may be provided via a web platform so that the users may play the electronic games via a web browser or a mobile software application. The use of the web platform provides various advantages to advertisers. First, the web platform may enable aggregating multiple metrics so that the advertisers can be provided with immediate advertisement campaign results on brand recall, brand lift, brand awareness, brand association, brand favorability, purchase intent, engagement, interaction times, and so forth. Second, the advertisers may incentivize, promote or encourage the users to play various electronic games, and thus interact with advertisements.

In one example, the users may be rewarded with virtual points for wining an electronic game. The virtual points can then be redeemed by the users, for example, for a monetary or a non-monetary reward, a financial discount, products or services, and so forth. In additional embodiments, the virtual points can be donated or transferred to a third party. To accomplish this, the web platform may embed a dedicated payment Application Programming Interface (API) so that various websites and software applications may have access to the web platform and conduct data transfer related to the virtual points earned by the users. In other words, the virtual points may be rewarded to the users within the web platform, a third party website or system, or a combination thereof. API may also allow users to keep track of their accumulated virtual points and to transfer them to a third party, track their past game performance, rewards, bookmarked or saved advertisements, and so forth.

Thus, the disclosed methods and systems for advertisement of products, services or brands within electronic games provide a useful and effective way of promoting products in a way that that does not interfere with the playing experience. Additionally, advertisements are memorized by the players since they constitute either the background or a major part of the content of the electronic games, thereby allowing the users to interact with the information associated with the products being promoted. Furthermore, the disclosed methods and systems provide advertisers with a powerful tool for tracking and targeting the users through aggregation of multiple advertisement metrics.

In accordance with an aspect of the present technology, there is provided a computer-implemented method for advertising within an electronic game. An example method may comprise receiving a user request to initiate the electronic game for a user. The method may further comprise providing, in response to the user request, a graphical interface associated with the electronic game. The method may further comprise providing, within the graphical interface, one or more graphical objects representing advertisement content. The one or more graphical objects may constitute at least one subject of the electronic game or a background.

In various embodiments, the method may further comprise receiving one or more inputs from the user, the one or more inputs representing actions performed by the user while playing the electronic game. The method may further comprise transforming, in response to the one or more inputs from the user, the one or more graphical objects. The graphical objects can be initially hidden, distorted, skewed, dispersed, or invisible to the user. The method may further comprise presenting, in response to the one or more inputs from the user, at least one part of the one or more graphical objects initially hidden, distorted, skewed, dispersed, or invisible to the user. The method may further comprise providing, in response to the one or more inputs from the user, at least one additional graphical object representing the product. The graphical objects may comprise at least one piece of information identifying one or more of the following: a product, a service, and a brand. The graphical objects may comprise an image. The image can be a background image for the graphical interface of the electronic game, wherein the graphical interface is a multi-layer graphical interface. The at least one graphical object may comprise a video. The electronic game may comprise one or more of the following: a game of skill, a brain fitness game, and a quiz game.

The method may further comprise rewarding the user with virtual points for completing the electronic game. The rewarding can be based on one or more of the following: game performance, user skill improvement, game level, and game score. The method may further comprise additionally rewarding the user when fulfilling outlined progress and performance missions. The method may further comprise rewarding the user with one or more of the following: social recognition titles, virtual badges, and virtual emblems. The method may further comprise rewarding the user with one or more of the following: a financial discount, a free product, and a free service. The method may further comprise enabling the user to redeem the virtual points. The redeeming of the virtual points may comprise providing to the user one or more of the following: a monetary reward, a non-monetary reward, a financial discount, virtual currency, such as Facebook® credits, a rebate, and at least a part of the product.

The method may further comprise enabling the user to spend or transfer the virtual points to a third party, wherein the third party comprises one or more of the following: a third party website, a merchant, social media site, charity, and online store. The method may further comprise aggregating advertisement campaign metrics. The advertisement campaign metrics may comprise engagement metrics. The advertisement campaign metrics may comprise brand lift metrics. The advertisement campaign metrics may comprise cost-per-impression metrics or cost-per-engagement metrics. The advertisement campaign metrics may comprise cost-per-action metrics. The advertisement campaign metrics may comprise cost-per-play or cost-per-click metrics. The advertisement campaign metrics may comprise gaming analytics and heat maps representing advertisement effectiveness and interactivity metrics. The method may further comprise enabling advertisers to bid on desired advertisement placements and/or desired targeted audiences. The method may further comprise enabling the advertisers to select one or more targeting campaigns. Targeting campaigns may include targeting methods such as topic targeting, remarketing, placement targeting, social targeting, reserve, contextual, gender, age and interest targeting. The method may further comprise enabling the advertisers to select one or more third party websites and/or software applications to embed software widget. The software widget can be configured to enable the user to play the electronic game via the third party website, wherein the software applications is configured to enable the user to play the electronic game.

The method may further comprise prompting the user to play an additional electronic game or participate in a sweepstake, draw or a survey. The method may further comprise prompting the user to share, rate, recommend, save or bookmark the one or more electronic games and/or one or more advertisement contents. The method may further comprise generating one or more recommendations to suggest the user to play one or more electronic games. The one or more recommendations are generated based upon advertisement campaign metrics and/or aggregated user shares, ratings, saved and bookmarked electronic games and/or advertisement contents. The method may further comprise enabling the advertisers to select one or more third party websites and/or software applications to embed software widget. The software widget can be configured to enable the user to play the electronic game via the third party website, wherein the software applications is configured to enable the user to play the electronic game. The method may further comprise prompting the user to make a purchase of a product or service.

The method may further comprise generating one or more software widgets to be embedded into a third party website, the software widget being configured to enable the user to play the electronic game via the third party website. The method may further comprise generating Application Programming Interface (API) codes. API codes can be configured to enable the user to play the electronic game and/or track their gaming activity, performance, and collected virtual points via the third party website or a software application. The method may further comprise enabling advertisers to upload, generate, and edit the one or more graphical objects.

In accordance with another aspect, there is provided a system for advertising within an electronic game. An example system may comprise a communication module configured to receive a user request to initiate the electronic game for a user, a graphical interface module configured to provide, in response to the user request, a graphical interface of the electronic game, and an advertisement module configured to provide, within the graphical interface, one or more graphical objects representing advertisement content. The one or more graphical objects may constitute at least one subject of the electronic game or a background.

In various embodiments, the communication module may be further configured to receive one or more inputs from the user, the one or more inputs represent actions performed by the user within the electronic game. The advertisement module may be further configured to transform the one or more graphical objects, in response to the one or more inputs from the user. The one or more graphical objects can be initially hidden, distorted, skewed, dispersed, or invisible to the user, and the advertisement module may be further configured to present, in response to the one or more inputs from the user, at least one part of the one or more graphical objects being previously hidden, distorted, skewed, dispersed, or invisible to the user. The advertisement module can be further configured to provide, in response to the one or more inputs from the user, at least one additional graphical object representing the product. The system may further comprise a rewarding module configured to reward the user with virtual points for playing the electronic game. The system may further comprise an aggregation module configured to aggregate advertisement campaign metrics.

In accordance with yet another aspect, there is provided a processor-readable medium having instructions stored thereon. The instructions, when executed by one or more processors, may cause the one or more processors to: receive a user request to initiate the electronic game for a user, provide, in response to the user request, a graphical interface of the electronic game, and provide, within the graphical interface, one or more graphical objects representing advertisement content. The one or more graphical objects may constitute at least one subject of the electronic game or a background.

To the accomplishment of the foregoing and related ends, the one or more aspects comprise the features hereinafter fully described and particularly pointed out in the claims. The following description and the drawings set forth in detail certain illustrative features of the one or more aspects. These features are indicative of just a few of the various ways in which the principles of various aspects may be employed, and this description is intended to include all such aspects and their equivalents.

### BRIEF DESCRIPTION OF THE DRAWINGS

Embodiments are illustrated by way of example, and not limitation, in the figures of the accompanying drawings, in which like references indicate similar elements and in which:

FIG. 1 shows a block diagram illustrating a system environment suitable for implementing methods for advertisement of products within electronic games.

FIG. 2 shows a block diagram of promotion system according to an example embodiment.

FIG. 3 is a process flow diagram showing a method for advertisement of products within electronic games, according to an example embodiment.

FIG. 4 shows a graphical user interface representing a front page of gaming website according to an example embodiment.

FIG. 5 shows a graphical interface representing the electronic game “Matercards” according to an example embodiment.

FIG. 6 shows a graphical interface representing the electronic game “Draggers” according to an example embodiment.

FIG. 7 shows another graphical interface representing the electronic game “Straighten the Frame” according to an example embodiment.

FIG. 8 shows another graphical interface representing the electronic game “Flashing Numbers” according to an example embodiment.

FIG. 9 shows a graphical interface representing a third party website having a software widget enabling to play an electronic game.

FIG. 10 shows a graphical interface representing a gaming website after an electronic game is played.

FIG. 11 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made, without departing from the scope of what is claimed. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computer system or in hardware utilizing either a combination of microprocessors, or other specially designed application-specific integrated circuits (ASICs), programmable logic devices, or various combinations thereof. In particular, the methods described herein may be implemented by a series of computer-executable instructions residing on a storage medium such as a disk drive or a computer-readable medium.

The embodiments described herein relate to computer-implemented methods for advertisement of product, services or brands within an electronic game. These methods can be implemented utilizing a number of various devices/systems including, but not limited to, computers (including tablet computers or tabletop computers), servers (e.g., web-enabled servers), cellular phones, smart phones, mobile devices, game consoles, television sets, smart televisions (i.e., television sets having ability to transmit and receive data over the Internet and also process this data), Personal Digital Assistants (PDAs), or any combination thereof. Under the term “advertisement” it is meant any visual or audiovisual form of communication used to encourage or persuade users (i.e., players of the electronic game) to make purchase decisions with respect to a certain company, organization, product, service, contract, and so forth. The advertisements may also include any form of sales promotion, marketing, crowdsourcing, public messaging, and the like. According to various embodiments, the advertisements are presented in the form of an image, animated image, or multimedia content (e.g., audio- and video content) such that it is incorporated into the electronic game graphical interface as a background or as a subject of the electronic game.

The term “electronic game”, as used herein, refers to any computer-implementable game, which involves interaction of a user with a graphical interface of the electronic game to generate visual feedback once certain actions are performed by the user. The terms “computer game,” “video game,” “Personal Computer (PC) game,” “online game,” “browser game,” and “Internet game” all refer to electronic games and fall within the spirit and scope of the present disclosure. According to various embodiments, the electronic games include brain games, brain fitness games, games of skill, development games, and so forth. Examples of the brain fitness games include memory games, concentration games, problem solving games, language games, logic games, visual games, and so forth. Among such electronic games are, for example, the following games: “Spot the Differences,” “Speed Images,” “Flashing Numbers,” “Flashing Tiles and Guess,” “Anagram words”, “Memory Matching,” “Mine Hunter,” “Masterpieces,” “Draggers,” “The Image Quiz,” “Number Hunt,” “Sudoku,” “Chinese Checkers,” “Mastermind,” “Counterfeit,” “Guess the Color,” “RwinCol,” “Checkers,” and so forth.

The present teachings involve a platform (e.g., a web-enabled platform), which enables users to play electronic games via a browser, software application, mobile software application, or the like using any suitable computing device having networked connectivity (e.g., a computer, mobile device, smart phone, smart televisions, and game console). To enable users to play electronic games via the browser, a gaming website can be established for this purpose. The electronic games can be featured with advertisements so that the users may play the electronics games free of charge or have a financial discount on the play. While playing the electronic games, the user may be awarded with virtual points or prizes based on the users' level of skill, performance, engagement, time spent on the game, number of wins, speed, and so forth. The virtual points can be further redeemed in the form of a monetary reward, a non-monetary reward, virtual currency, such as Facebook® credits or the like, a financial discount, cash, a rebate, at least a part of a product or service, or free of charge products or services. Accordingly, the advertisers can engage the users to play the electronic games designed around their advertisements by rewarding the users with various virtual points or prizes. It should be mentioned that the virtual points can be rewarded within the platform or any other website or web-enabled system, or a combination thereof. In addition, redeeming of the virtual points can be performed either within the platform or at any third party website.

In various embodiments, the electronic games have multi-layer graphical interface, where one of the layers of graphical interface is a background. The present teachings involve placement of the advertisement image or video within the background layer. Yet, in other embodiments, the advertisement image or video may constitute a subject of the electronic game so that the user may manipulate this subject (move, transform, activate, change characteristics, and so forth). In either case, the users interact with the advertisement image or video all or most of the times they play the electronic game. The impact on the users and memorizing of the advertisement image or video placed within the graphical interface is enhanced comparing to those advertisements which are presented to the users in a traditional way (e.g., in the form of banners or pop-up windows).

According to various embodiments, when the electronic game is initiated, the advertisement image or video can be hidden, broken into multiple parts, invisible (at least in part) or non-recognizable to the users. When the users play the electronic game, one or more inputs can be made by the users, while the inputs represent certain actions. In response to various certain actions, the advertisement image or video may gradually become visible. For example, once the users make certain action(s), at least one fragment of the advertisement image or video can be displayed for the user. According to other embodiments, the advertisement image or video can be presented to the users constantly. It should be understood that various implementations are possible, depending on a game type.

In terms of electronic game rewards, the users can track their performance over time by having electronic games tailored for different brain functions such as memory, attention, concentration, mental agility, problem solving, speed, reflex, flash memory, and recall. In terms of redeemable rewards, the users may be rewarded with virtual points, cash, virtual currency, financial discounts, giveaways, contests, sweepstakes, and promotions for playing the electronic games free of charge. The users can be rewarded based on their performance, so the better they play one or more electronic games, the more virtual points and/or rewards they can obtain or redeem. Another way for users to win rewards is by fulfilling progress and performance missions. The rewards can also be provided and/or redeemed via a website which the users access to play electronic games or any other partnering website.

In operation, the users may first need to sign up via a website providing access to various electronic games or social media site (e.g., a social networking site or blogging site). By signing up, the users may establish profiles allowing tracking their performance, progress in developing one or more skills, accumulated virtual points, titles, levels, fulfilled missions, and virtual prizes such as emblems, as well as tracking rankings on leaderboards between various users, comparing and analyzing results based upon age groups, territory, country, state, city, and keeping track of redeemed rewards, saved advertisements, and so forth. The users can play the electronic games via the website using various software widgets and/or via API codes. In one example, the users can play the electronic games via multiple social media websites. Alternatively, the users may play the electronic games and access their profiles via mobile software applications installed onto their computing devices.

After having played an electronic game, the users can be presented with multiple reward options. In an example, every time the users win an electronic game, the users may be presented with three reward options to choose from. The users may choose to receive a certain amount of virtual points for having won the electronic game (the amount virtual points may depend on the user's performance, difficulty of the electronic game, speed, and so forth). Additionally, the users may be prompted to play an additional electronic game, watch a promotional video, or answer a survey or poll. In this case, the users may be provided with greater amount of virtual points. Furthermore, the user may choose to receive a financial discount or giveaway on a good or service (this reward may also depend on the user's performance, game difficulty level, and score). Moreover, the user may also be prompted to enter in a draw to win a product or a service (in this case the amount of awarded virtual points can be decreased or, in other words, the user may need to spend some of earned virtual points to be able to enter a draw or have a financial discount/giveaway).

In general, the virtual points earned by the users can be redeemed, converted, transferred, or donated. Accordingly, there can be provided one or more software widgets (and/or various API codes). A redeem widget may allow the users to spend the virtual points on redeeming monetary or non-monetary rewards. A converting widget may allow the users to convert certain amount of virtual points into money or virtual currency (e.g., Facebook® credits). There can be also provided an unlock widget allowing the users to “unlock” or purchase content. Yet another widget can be a donate widget allowing the users to giveaway virtual points to third parties (charities, non-profit organizations, etc.). Dedicated API codes may also be used to allow third party software, mobile applications, websites, etc. to communicate with the platform, receive information on virtual points, allow the users to earn or deal in virtual points of these third party systems, and have other benefits.

As mentioned, the present teachings further enable aggregating various advertisement metrics. Therefore, the advertisers or any involved party may measure the impact of their advertisement campaigns. In particular, the advertisers can be provided with immediate advertising campaign metrics on brand recall, brand lift, brand attention, brand engagement, memory and interaction times, awareness, brand favorability, purchase intent, cost-per-click, cost-per-impression, cost-per-engagement, cost-per-play, and so forth.

According to various embodiments, the advertisers may launch the advertisement campaigns based upon various metrics such as cost-per-click metrics, cost-per-impression metrics, cost-per-engagement metrics, and cost-per-play metrics. Hence, the advertisers are able to pay only when there has been guaranteed engagement. The advertisers can select or establish a target advertisement campaign based upon one or more of mentioned metrics. For example, the advertising campaigns can be based upon cost-per-click metrics, cost-per-impression metrics, cost-per-engagement metrics, or cost-per-play metrics. Thus, the advertisers can have accurate metrics of how many users were actually engaged with their advertisements. Moreover, the advertisers can have accurate expectations on their future campaign and may plan advertisement campaigns and limit them, for example, to target demographics, geographical locations, interests, gender, age, and shopping habits. In yet additional examples, the advertising metrics can be retrieved and presented in various ways so as to be easy to read and understand.

It should be also mentioned that the present teachings enable the users to communicate with each other and/or play with each other. In yet other embodiments, the users may be enabled to play private games on their own. Moreover, the electronic games' results can be shared via various ways including leaderboards within the gaming website, as well as via third party sites such as social networking sites and social media sites. Information associated with users' activity may aggregate all the gaming and rewarding activities that the users are engaged on the gaming website and across third party partner websites. The users' activity may also demonstrate user performance results and demonstrate various activities.

As mentioned above, the users may wish to visit third party partner websites having specific widgets to play games or may visit the gaming site itself. In the latter case, the gaming website may act as a “social gaming hub”, which may have connectivity with multiple third party websites. In an embodiment, the users may establish personal profiles to track their activity and performance, collect virtual prizes or virtual currency, communicate with other players, share game results, comment on the game results of other users, and so forth. In yet further embodiments, the gaming website may have connectivity with third party websites so that the users may be awarded virtual points or rewards at such third party websites which can be social media sites or social networking sites. More specifically, at the third party websites, the users may be able to win virtual emblems, virtual points, virtual badges, compare their performance to that of their age group, friends and global population. An activity stream built within such third party websites may be constantly updated with other users gaming activities. The activity stream may also show updates of scores that other users are receiving in real time, the advertisements and brands associated with the games, the virtual badges they are winning, the virtual points they are earning, the draws they are entering, and so forth. The gaming website may also enable users to convert their virtual points from one virtual currency to another (e.g., to convert gaming website virtual points to Facebook® credits).

In addition, the present disclosure may further enable the users to spend virtual points in a number of different ways. In an example, the users may spend the virtual points to enter in a draw to win a discount or giveaway of a product or service, play additional electronic games, or simply exchange the virtual points onto a free of charge product, service, or a financial discount. The amount of virtual points that can be earned by the users may depend on their performance, activity, game level, time spent on a game, and so forth. Thus, the better the users play game, the more virtual points they can earn, and more valuable prizes (products, services) they can win or exchange for the earned virtual points.

Therefore, the present disclosure provides useful and effective methods for promotion of products, services, and brands within graphical interface of various electronic games such as brain fitness games. While the users are allowed to play the electronic games and win rewards, the advertisers may effectively run advertising campaigns ensuring guaranteed engagement of the users. The advertisers may also be able to review valuable marketing information and advertisement metrics including advertisement campaign results associated with brand recalls, brand lifts, brand awareness, brand association, brand favorability, purchase intent, message association, engagement, interaction times, and so forth. The advertisers may define how their advertisement content appears in various electronic games, the audiences (by defining age groups, territories, occupations, and so forth), frequency of advertisement placement, and so forth. In various embodiments, the advertisers may provide their virtual profiles on the gaming site to facilitate the process of aggregating and reviewing the advertising metrics.

Furthermore, the advertisers may bid to place their advertisement content, frequency of display, audiences, particular placements, and so forth. The audiences may include groups of users having similar interests, age, location, and so forth. For example, the users may be provided with one or more daily recommended games or a daily training session when visiting the gaming website. The advertisers may place bids on the placement of their advertisement content so that, for example, the higher the bid, the higher their advertisements ranks among the today's recommended games list. According to an additional embodiment, the amount of rewarded virtual points can be based on the size of the advertiser's bid.

Accordingly, while the present disclosure may enable users to play brain fitness games free of charge, advertisers are able to place advertisement content which is incorporated within the electronic games. Typically, a marketing research will include polls, questionnaires, surveys, and so forth while the present disclosure enables aggregating marketing information and conducting advertisement research in an easy and entertaining manner, i.e. by providing the advertising content as a background or subject of the electronic games.

In yet other embodiments, the advertisers may upload or generate graphical objects to be embedded into the electronic games as advertisements. Further, the advertisers may also edit such graphical objects.

The following provides the detailed description of multiple embodiments related to methods and systems for advertising of products with electronic games.

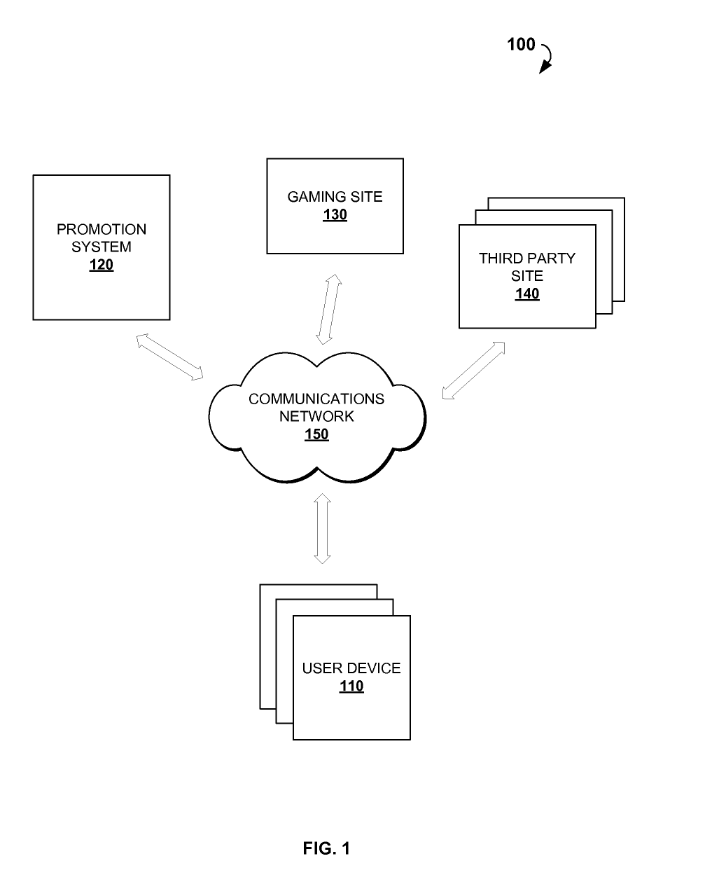

Referring now to the drawings, FIG. 1 shows a block diagram illustrating a system environment 100 suitable for implementing methods for advertisement of products or brands within electronic games. In particular, the system environment 100 comprises multiple user devices 110, a promotion system 120, a gaming site 130, one or more third party sites 140, and a communication network 150, which may operatively couple all mentioned modules.

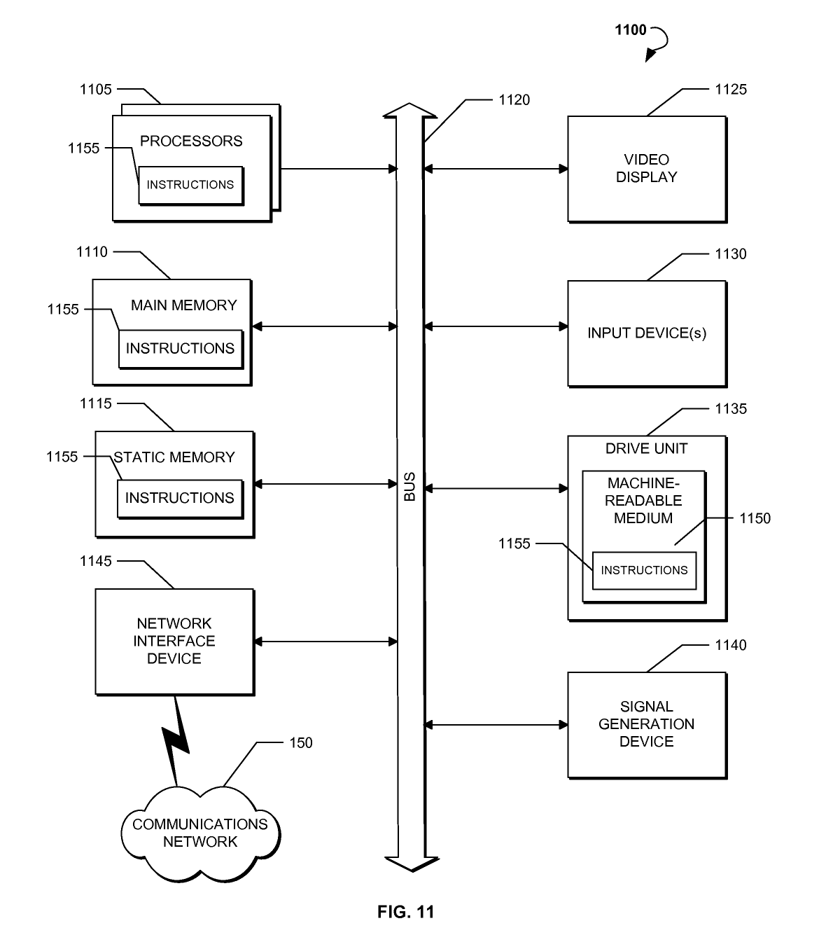

In general, each user device 110 refers to an electronic computing device having networked connectivity. Examples of the user devices 110 include a computer (including a laptop computer, a desktop computer, a tablet computer, and a portable computing device), a server, a thin client, PDA, handheld cellular phone, mobile phone, smart phone, game console, smart television, and so forth. Accordingly, the user devices 110 may have at least a network interface allowing communication with the promotion system 120, the gaming site 130, or the third party sites 140. The user devices 110 may also have an input device to enable the users to make input and/or a display. The input device may include, but is not limited to, a keyboard, keypad, touchpad, touchscreen, mouse, gamepad, joystick, microphone, and so forth. The display may be any suitable displaying device such as a flat panel, Liquid Crystal Display (LCD), Organic Light Emitting Diodes (OLED) display, and so forth. Some other devices and modules of the user devices 110 are described below with reference to FIG. 11.

The promotion system 120 is configured to implement methods for advertisement of products within electronic games as described herein. The promotion system 120 may be implemented as computer codes, software, firmware, hardware, or any combination thereof. In an example, the promotion system 120 is configured as a stand-alone system (e.g., a server), which can be accessed via the communications network 150. In particular, the user devices 110 may have a browser or dedicated software application to communicate with the promotion system 120. Although the method steps for advertisement of products within electronic games are implemented by the promotion system 120, it should be understood that only some method steps can be performed by the promotion system 120, while other method steps can be performed by the user devices 110 separately or in combination with activity performed by the promotion system 120. In other words, the promotion system 120 can either be integrated into the user device 110 (e.g., as a mobile software application), be a stand-alone system, or both. In either case, the promotion system 120 is configured to implement, or facilitate implementation of, the methods for advertisement of products within electronic games as described herein.

With continuing reference to FIG. 1, there is also shown the gaming site 130 which can be hosted by a stand-alone server or the promotion system 120. The gaming site 130 may enable the users of the user devices 110 to play various electronic games via a browser. More specifically, by visiting the gaming site 130, the users may establish profiles, play various electronic games, may be provided with various recommended game training sessions, track their progress in developing certain skills, receive and track virtual points for playing the electronic games, engage in social gaming activities, save or bookmark interesting advertisements, rate electronic games, advertisers or advertisements, have access to online stores, and redeem or convert the virtual points. The gaming site 130 can be also used by the advertisers launch various advertising campaigns, track various advertisement campaign metrics, provide prizes (e.g., access to particular content), communicate, change settings of the advertising campaigns, bid on audiences and advertisement placements, and so forth. Similarly, the advertisers may establish dedicated profiles to facilitate their interaction with the gaming site 130.

It should be mentioned that the gaming site 130 may interact with the promotion system 120. Accordingly, while the gaming site 130 may enable the users of the user devices 110 to play various electronic games, the promotion system 120 may track playing the electronic games, aggregate advertisement campaign metrics, reward the users with virtual points, and so forth. In other words, the gaming site 130 may merely construe a “gateway” for the users to interact with the promotion system 120. It should be understood that in various embodiments the gaming site 130 may be a part of the promotion system 120.

With continuing reference to FIG. 1, the one or more third party sites 140 may refer to any website which may interact with the promotion system 120 and which can be accessed by the users of the user devices 110. Examples of third party sites 140 may include social media sites, third party gaming websites, news websites, niche websites, and so forth. The term “social media” site, as used herein, refers to various online and software tools that enable people to communicate via the communications network 150 and share information and resources (text, audio, video, images, podcasts, and other multimedia). The social media sites may include social networking sites, blogs, micro-blogs, podcasts, chats, web feeds, content-sharing tools, and so forth.

In an example embodiment, the one or more third party sites 140 may be provided with a software widget to enable visitors of the one or more third party sites 140 to play electronic games associated with the promotion system 120 such that the methods for advertisement of products within electronic games, as described herein, are implemented. In yet another example, the one or more third party sites 140 may be used by the users to log in to their profiles associated with the promotion system 120. For example, once the users log in to a social networking site, the users are automatically logged in to the gaming site 130 and/or the promotion system 120.

With continuing reference to FIG. 1, the communications network 150 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network. The communications network 150 can further include or interface with any one or more of the following: RS-232 serial connection, IEEE-1394 (Firewire) connection, Fiber Channel connection, IrDA (infrared) port, SCSI (Small Computer Systems Interface) connection, USB (Universal Serial Bus) connection, or other wired or wireless, digital or analog interface or connection, mesh or Digi® networking.

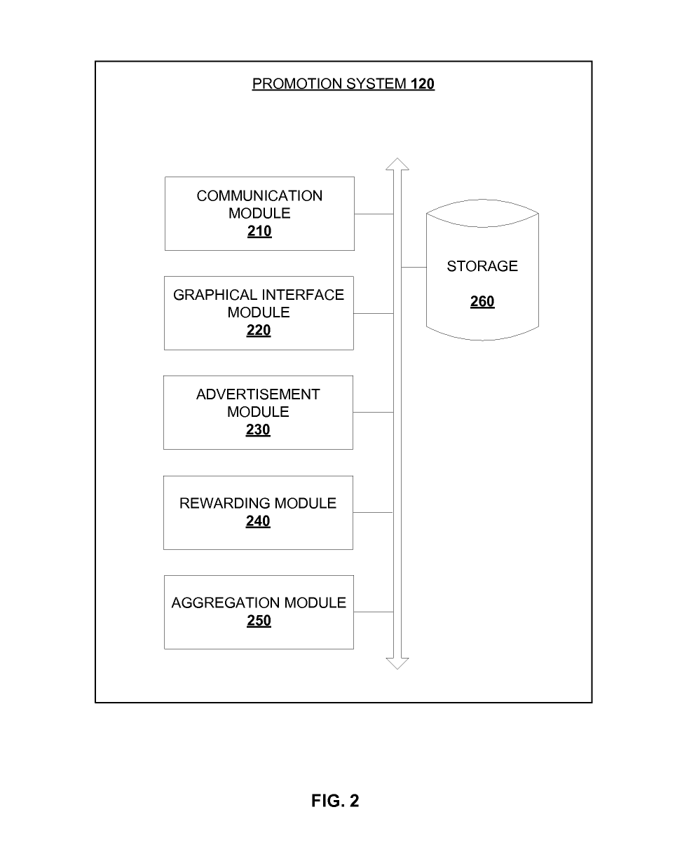

FIG. 2 shows a block diagram of the promotion system 120 according to an example embodiment. In this embodiment, the promotion system 120 may include, embed, or be coupled to a communication module 210, a graphical interface module 220, an advertisement module 230, a rewarding module 240, an aggregation module 250, and storage 260. The promotion system 120 may be operatively coupled to or embed the gaming site 130. All of these modules 210-260 can be integrated within a single apparatus, or, alternatively, can be remotely located and optionally accessed via a third party. The promotion system 120 may further include additional modules, but the disclosure of such modules is omitted so as not to burden the entire description of the present teachings.

In general, the communication module 210 can be configured to enable communication between the promotion system 120 and the user devices 110, the gaming site 130, and the one or more third party sites 140. The communication can be either direct or via the communications network 150. More specifically, the communication module 210 can be configured to receive user requests to initiate an electronic game within the gaming site 130 or a mobile software application installed in the user device 110. The communication module 210 can be further configured to receive one or more inputs from the user. The one or more inputs can be made via the user devices 110 and represent actions performed by the user within the electronic game currently played.

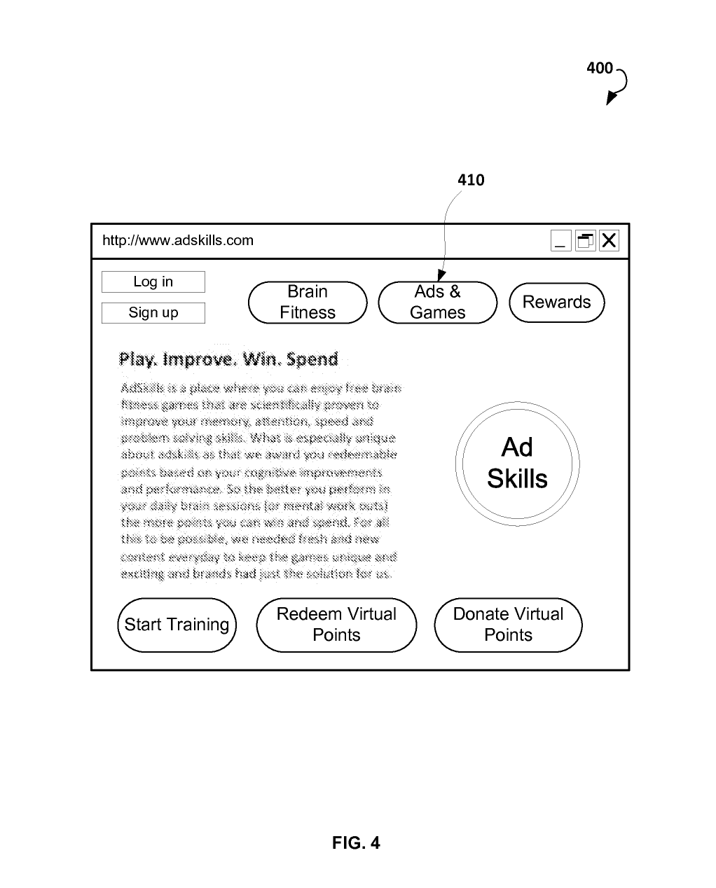

With continuing reference to FIG. 2, the graphical interface module 220 can be configured to provide graphical interfaces of electronic games. In particular, the graphical interfaces are provided in response to the user requests. It should be understood that the graphical interfaces are provided via the gaming website 130 or third party website 140 with the help of one or more software widgets embedded therein. Alternatively, the graphical interfaces can be provided via the mobile software application installed in the user device 110. Various examples of the graphical interfaces are given in FIGS. 4-8, which are described below.

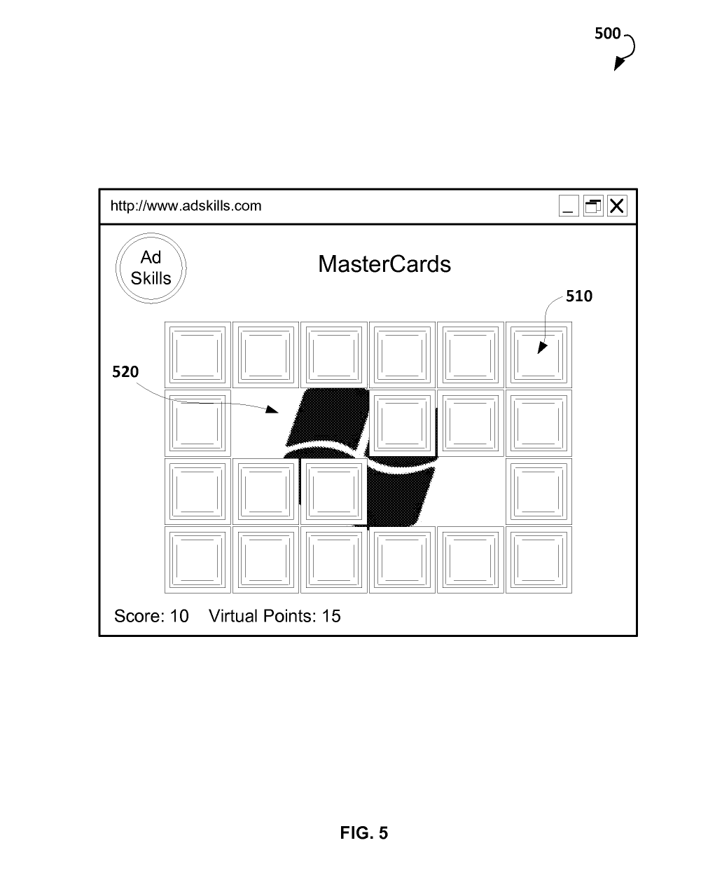

The advertisement module 230 can be configured to provide, within the graphical interface provided by the graphical interface module 220, various graphical objects representing the promoted product or service. More specifically, in an embodiment, the graphical objects may be presented as a background of the graphical interface, when the graphical interface has multi-layered structure. For example, the graphical objects may be a background image or video displayable within the background layer. In other embodiments, the graphical objects may be presented as a subject of the electronic game. For example, the graphical objects representing the promoted product can be a major subject of electronic game, on which the users perform actions. It should be understood that certain actions under the graphical objects representing the promoted product may be various and depend on game type. Some example actions include movement of graphical objects, their rotation, visual transformation, color transformation, scale transformation, and so forth. Accordingly, the advertisement module 230 can be further configured to transform one or more graphical objects, in response to the one or more inputs from the user as received by the communication module 210. A few examples of the graphical objects are given below with reference to FIGS. 5-9.

In addition, the advertisement module 230 can be configured to provide at least one additional graphical object representing the promoted product, service or brand, in response to the one or more inputs from the user as received by the communication module 210. In general, the graphical objects and additional graphical objects comprise at least one item of information identifying the product, service or brand (e.g., a name, term, design, symbol, logo, slogan, or any other feature that identifies a company, product or service). Examples of the graphical objects and additional graphical objects may include images, animated images, video, multimedia content, text, and so forth.

With continuing reference to FIG. 2, the rewarding module 240 can be configured to reward the users with virtual points for playing the electronic games. The rewarding module 240 can be further configured to enable the user to redeem, spend, or transfer the virtual points in one or more ways as described above. The virtual points can be rewarded based upon performance of the users, speed, time spent on the game, development of their skills, fulfilled missions, and so forth.

The aggregation module 250 can be configured to aggregate and/or calculate various advertisement campaign metrics during the times the users play the electronic games. The advertisement campaign metrics may comprise one or more of the following: engagement metrics, brand lift metrics, cost-per-impression metrics, cost-per-engagement metrics, cost-per-play metrics, cost-per-click metrics, interaction times, brand awareness, brand favorability, purchase intent, brand recall, and so forth. Accordingly, the advertisers may track various advertisement campaign metrics, plan future targeted advertisement campaigns, and pay for the advertisement campaigns based upon guaranteed engagement of the users.

The storage 260 can be configured to store user profiles, game data, game settings, messages, settings, aggregated advertisement campaign metrics, graphical interfaces, game analytics, graphical objects, images, video, multimedia content, rules, websites, and so forth. Accordingly, in operation, each time the users initiate an electronic game, corresponding data is retrieved from the storage 260 to provide graphical interface of the requested electronic game, its functionality, graphical objects representing promoted products or services, settings, and so forth. Further, while the user plays the electronic game, various advertisement campaign metrics are aggregated and stored in the storage 260.

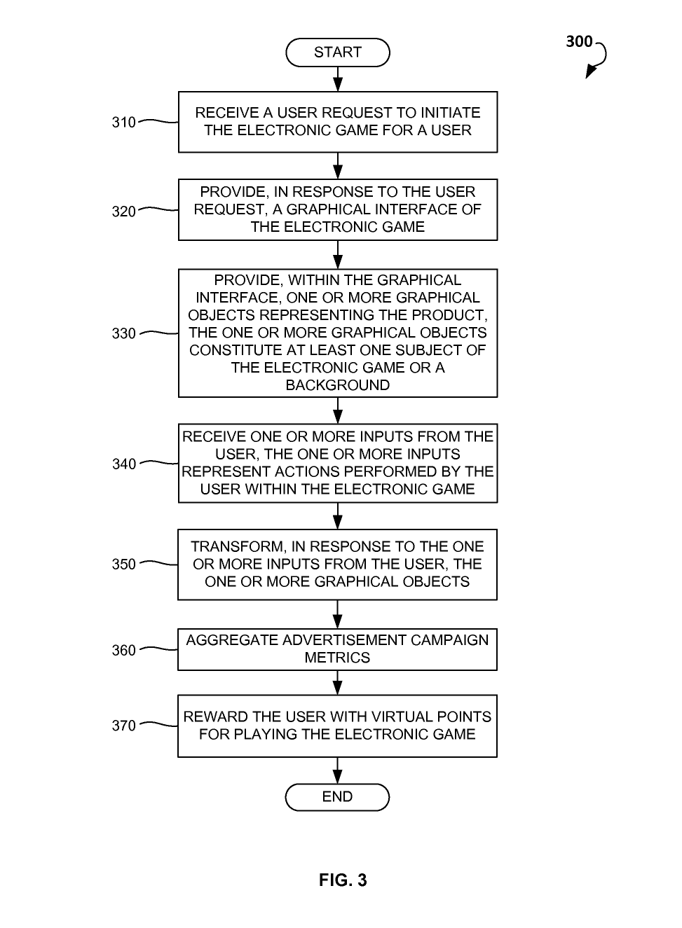

FIG. 3 is a process flow diagram showing a method 300 for advertisement of products within electronic games, according to an example embodiment. The method 300 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the promotion system 120. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

As shown in FIG. 3, the method 300 may commence at operation 310 with the communication module 310 receiving a user request to initiate an electronic game for the user. The user request can be generated by the user device 110 while the user browses the gaming site 130, involved third party site 140, or interact with dedicated mobile software application installed in the user device 110. As mentioned, the electronic game may refer to brain fitness game, game of skill, development game, or the like.

At operation 320, in response to the user request, the graphical interface module 220 provides a corresponding graphical interface of the electronic game. The graphical interface is provided via the gaming site 130, involved third party site 140, or mobile software application installed in the user device 110. In various embodiments, the graphical interface of the electronic game may be multi-layer graphical interface.

At operation 330, the advertisement module 230 provides, within the graphical interface, one or more graphical objects representing the product or service to be promoted. In one embodiment, mentioned one or more graphical objects constitute at least one subject of the electronic game (which subject can be affected by various user actions). In another embodiment, mentioned one or more graphical objects constitute a background image or video of the multi-layer graphical interface.

At operation 340, the communication module 210 continuously receives inputs from the user device 110. These inputs represent actions performed by the user within the electronic game. Actions may be various depending on the electronic game played.

In multiple embodiments, the actions can be performed under the graphical objects representing the product or service to be promoted. Accordingly, at operation 350, the advertisement module 230 transforms, in response to the one or more inputs from the user, the one or more graphical objects. For example, the user may transform the graphical objects, change their color, shape, scale, position within the graphical interface, and so forth.

At operation 360, the aggregation module 250 aggregates (and/or calculates) various advertisement campaign metrics. As mentioned, the advertisement campaign metrics may comprise one or more of the following: engagement metrics, brand lift metrics, cost-per-impression metrics, cost-per-engagement metrics, cost-per-play metrics, cost-per-click metrics, interaction times, brand awareness, brand favorability, purchase intent, brand recall, and so forth. Once the advertisement campaign metrics is aggregated, it can be stored in the storage 260 and further processed.

At operation 370, the rewarding module 240 rewards the user with virtual points for playing the electronic game. It should be understood that the virtual points can be rewarded differently based upon the electronic game played, rules, settings, user's performance, developed skills, previous results, aggregated advertisement campaign metrics, the amount and size of the advertiser's bid, and so forth. The rewarded virtual points can be further redeemed, transferred, or exchanged in a number of various ways as described above.

FIG. 4 shows a graphical interface 400, displayable on the user device 110, representing a front page of the gaming website 130, according to an example embodiment. The graphical interface 400 may be represented as a window (e.g., a browser window) to show its content. In one example, the graphical user interface 400 may be shown on a display of the user device 110 via a browser or dedicated mobile software application.

More particularly, the graphical interface 400 is displayed to the users, which are successfully logged in to the gaming website 130 (or the promotion system 120). As shown in the figure, the users are faced with options to take a training program, read gaming recommendations, review gaming history, review earned virtual points rewarded, redeem the virtual points, and donate the virtual points. Accordingly, the graphical interface 400 may comprise multiple actionable buttons, controls, icons, hyperlinks, text boxes, images, videos, etc. For example, the graphical interface 400 comprises an actionable button 410 “Ads & Games,” by activating which the users are taken to another web page, where the users will be able to play various electronic games. Those skilled in the art would appreciate that the graphical user interface 400 may include additional, fewer, or different sections depending on application.

FIG. 5 shows a graphical interface 500, displayable on the user device 110, representing the electronic game “Matercards”. The graphical interface 500 may be represented as a window showing content. In one example, the graphical user interface 500 may be shown on a display of the user device 110 via a browser or dedicated mobile software application.

The electronic game “Matercards” refers to an observational memory game. As shown in the figure, the graphical interface 500 presents multiple virtual cards 510. Once the user clicks on first virtual card 510, its back side with a first image is shown. Furthermore, the user can be prompted to click on a second virtual card 510. Once the user clicks the second virtual card 510, the back side of the second virtual card 510 is shown with a second image. If the first image and the second image are the same, the corresponding first and second virtual cards 510 disappear. If the first image and the second image are not the same, the first virtual card 510 and the first virtual card 510 can revert to their initial states.

The virtual cards 510 can be seen as a background image 520. According to the shown example embodiment, the background image 520 is a graphical object representing a promoted product, service or brand. Thus, the background image 520 may include a logo, company name, brand message, advertisement, product's view, description of products or services, and so forth.

Once all virtual cards 510 disappear, the user can be presented with the entire background image 520 representing the promoted product, service, or company.

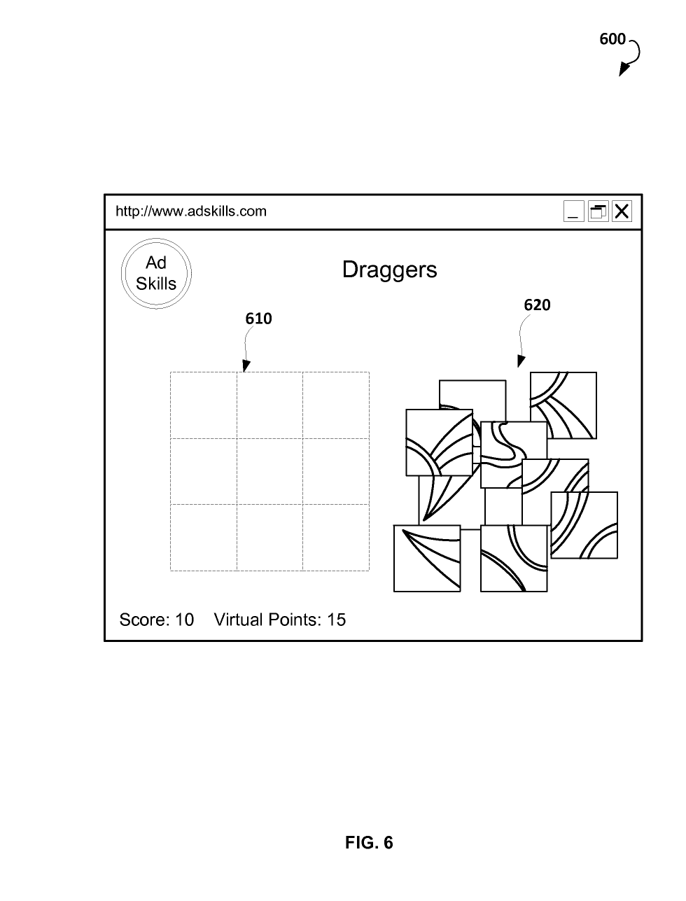

FIG. 6 shows a graphical interface 600 of the user device 110. The graphical interface displays the electronic game “Draggers”. The graphical interface 600 may be presented as a window showing content of the game. In one example, the graphical user interface 600 may be shown on a display of the user device 110 via a browser or dedicated mobile software application.

As shown in the FIG. 6, an area 610 can be separated onto nine squares by dashed lines. Additionally, there is a set of randomly placed images 620. The game “Draggers” enables moving the images 620 into the area 610 so that all images 620 assemble a single unified image. The unified image can include a logo of a promoted company, while the set of randomly placed images 620 can include a logo split onto multiple parts. Accordingly, each image 620 can include a graphical object including at least one subject of the electronic game.

Thus, the interaction of the user with the graphical object representing a promoted product, company, service, and so forth is enhanced, and the users typically remember the graphical object during a long time period.

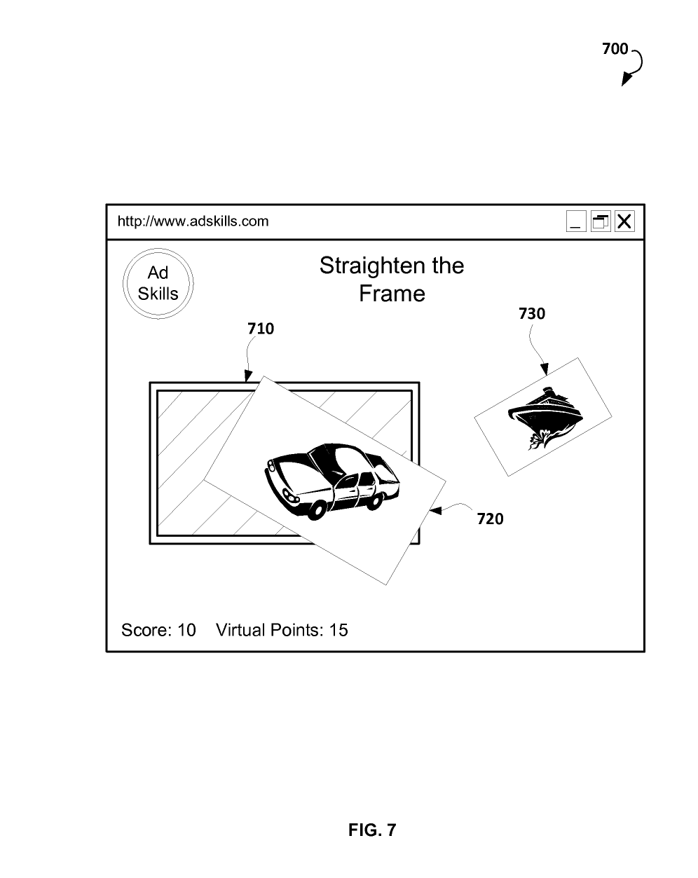

FIG. 7 shows another graphical interface 700, displayable on the user device 110, representing the electronic game “Straighten the Frame”. The graphical interface 700 may be represented as a window to show its content. In one example, the graphical user interface 700 can be shown on a display of the user device 110 via a browser or a dedicated mobile software application.

The electronic game “Straighten the Frame” is an attention concentration game. As shown in the FIG. 7, the graphical interface 700 includes a frame 710, a first image 720, and a second image 730. Both, the first image 720 and the second image 730 contain advertisement content such as an image of the promoted product, logo, company name, description of the product or service, and so forth.

The images 720 and 730 are presented in a skewed way and the users need to straighten them up as quickly as possible in order to position them within the frame 710. The way the users would straighten them would be by pressing the right arrow key on a keyboard to make one of the images tilt to the right and press the left arrow key on the keyboard to make the image tilt to the left. Every time the image is straightened, the users need to press either the top or bottom arrow keys to confirm the position of the image. If a user presses the bottom arrow key at the wrong time or when the image is not straightened yet, the user gets a virtual points penalty.

It should be mentioned that the users first presented with the first image 710 and are able to make modifications (tilting up or down, rotating, etc.) to the first image 710 only. The second image 720 is shown merely to inform the users what next image is.

Furthermore, in more advanced levels, it might be possible for the user being close to putting the ad back into the frame, to make either the top or bottom arrow key flashing (if the keys are shown on the display), the user will then have to press the correct arrow to pin the image into the frame.

The users may be provided with a chance of winning some bonus virtual points if they recreate the order the images appeared in. They may also get points for correct guesses.

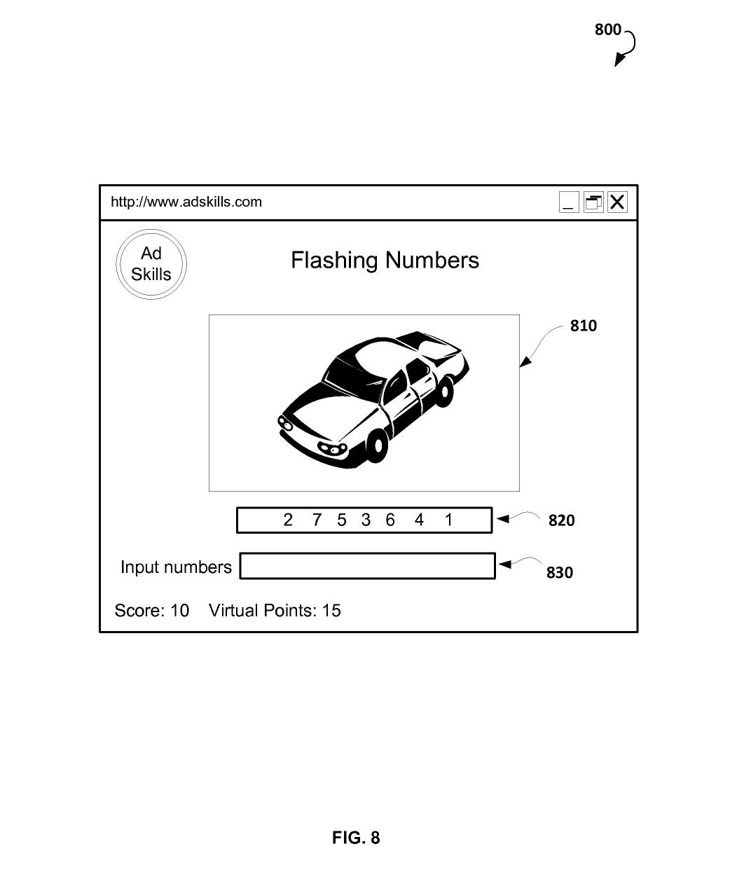

FIG. 8 shows another graphical interface 800, displayable on the user device 110, representing the electronic game “Flashing Numbers”. The graphical interface 800 may be represented as a window showing game content. In one example, the graphical user interface 800 may be shown on a display of the user device 110 via a browser or a dedicated mobile software application.

The electronic game “Flashing Numbers” is a observational memory game. The graphical interface 800 may comprise a background image 810 which has advertisement content such as an image of promoted product or service, company name, logo, and the like. The graphical interface 800 may further comprise a temporary window 820 which includes multiple numbers (e.g., from 1 to 10). The numbers may be flashing in the temporary window 820 and the user can be prompted to remember them and their order as quickly as possible. The numbers may flash during a predetermined time period and, after the time lapses, the temporary window 820 may disappear from the graphical interface 800. A new input window 830 may be presented to the user. The user may further be prompted to input the number as he or she remembers into the input window 830.

In various embodiments, the background image 810 may be initially invisible for the user, however every time the user enters a correct number into the input window 830, the background image 810 may become more visible. In an example, this game can be played for 12 rounds and by getting 10/12 rounds correct, the users can be provided with the full background image 810, i.e. in its original non-transparency state.

The number of virtual points rewarded to the user by the end of the game may depend on the user performance, the number of correctly input numbers, and other related metrics. It should also be mentioned that the temporary window 820 may show characters instead of numbers so that the user is prompted to input the characters into the input window 830.

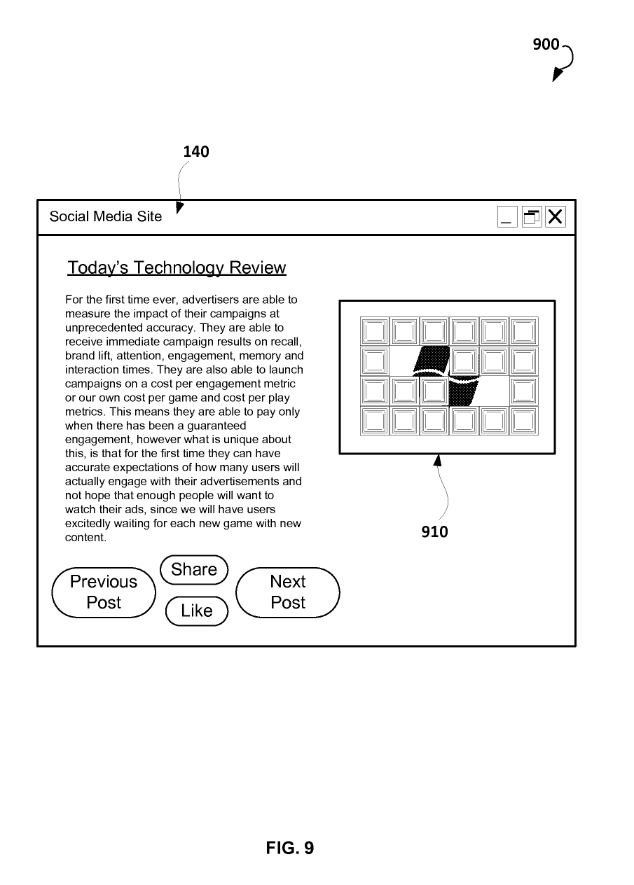

FIG. 9 shows a graphical interface 900, displayable on the user device 110, representing a third party website 140 having a software widget 910 enabling the users to play an electronic game. The graphical interface 900 may be represented as a window to show its content. In one example, the graphical user interface 900 may be shown on a display of the user device 110 via a browser or dedicated mobile software application.

As shown in the figure, the third party website 140 may refer to a social media site such as blogging site. In this example, the third party website 140 is a blogging site populated with posts such as “Today's Technology Review” or alike. The graphical interface 900 comprises the software widget 910 placed within the third party website 140. The software widget 910 enables the visitors of the third party website 140 to play various electronic games provided by the promotion system 120 and in accordance with the principles described herein.

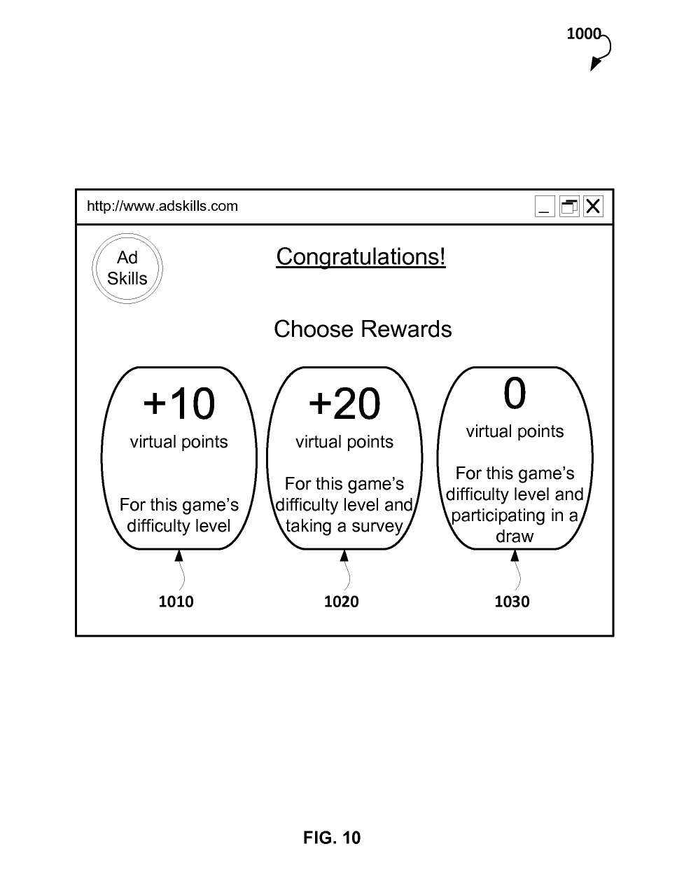

FIG. 10 shows a graphical interface 1000, displayable on the user device 110, representing the gaming website 130 after an electronic game is played. The graphical interface 1000 may be represented as a window to show its content. In one example, the graphical user interface 1000 may be shown on a display of the user device 110 via a browser or dedicated mobile software application.

As shown in the figure, after the user successfully finished an electronic game, the user may be faced with several options to choose a reward. In this example, the user may select one of three options. The first option (clickable button 1010) allows the user to earn ten virtual points for playing the game. The second option (clickable button 1020) allows the user to earn twenty virtual points for playing the electronic game and taking a survey about a product, service, or company. The third option (clickable button 1030) does not allow the users to earn any virtual points, however, the user may participate in a draw to win a monetary prize or may also automatically receive a financial discount or giveaway. It should be understood that in either case, once the user selects any of options, the profiles of the users will be updated and stored in the storage 260. Specifically, the total amount of virtual points earned will be updated in the storage 260, users' performance during the play will be recorded, various advertisement campaign metrics will be calculated and also stored in the storage 260, and so forth.

FIG. 11 shows a diagrammatic representation of a computing device for a machine in the example electronic form of a computer system 1100, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server, or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as a Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor or multiple processors 1105 (e.g., a central processing unit (CPU), a graphics processing unit (GPU), or both), and a main memory 1110 and a static memory 1115, which communicate with each other via a bus 1120. The computer system 1100 can further include a video display unit 1125 (e.g., a LCD or a cathode ray tube (CRT)). The computer system 1100 also includes at least one input device 1130, such as an alphanumeric input device (e.g., a keyboard), a cursor control device (e.g., a mouse), a microphone, a digital camera, a video camera, and so forth. The computer system 1100 also includes a disk drive unit 1135, a signal generation device 1140 (e.g., a speaker), and a network interface device 1145.

The disk drive unit 1135 includes a computer-readable medium 1150, which stores one or more sets of instructions and data structures (e.g., instructions 1155) embodying or utilized by any one or more of the methodologies or functions described herein. The instructions 1155 can also reside, completely or at least partially, within the main memory 1110 and/or within the processors 1105 during execution thereof by the computer system 1100. The main memory 1110 and the processors 1105 also constitute machine-readable media.

The instructions 1155 can further be transmitted or received over the communications network 150 via the network interface device 1145 utilizing any one of a number of well-known transfer protocols (e.g., Hyper Text Transfer Protocol (HTTP), CAN, Serial, and Modbus).

While the computer-readable medium 1150 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C#, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

Thus, computer-implemented methods and systems for advertising products or services within graphical interfaces of various electronic games, such as brain fitness games, are described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for advertising within an electronic game, the method comprising:
receiving a user request to initiate the electronic game for a user;
providing, in response to the user request, a graphical interface of the electronic game; and
providing, within the graphical interface, one or more graphical objects representing advertisement content, wherein the one or more graphical objects constituting at least one subject of the electronic game or a background.

2. The method of claim 1, further comprising receiving one or more inputs from the user, the one or more inputs represent actions performed by the user within the electronic game.

3. The method of claim 2, further comprising transforming, in response to the one or more inputs from the user, the one or more graphical objects.

4. The method of claim 2, wherein the one or more graphical objects are initially hidden, distorted, skewed, dispersed, or invisible to the user.

5. The method of claim 4, further comprising presenting, in response to the one or more inputs from the user, at least one part of the one or more graphical objects being initially hidden, distorted, skewed, dispersed, or invisible to the user.

6. The method of claim 2, further comprising providing, in response to the one or more inputs from the user, at least one additional graphical object representing the product.

7. The method of claim 1, wherein the at least one graphical object comprises at least one item of information identifying one or more of a product, a service, or a brand.

8. The method of claim 1, wherein the at least one graphical object comprises an image.

9. The method of claim 8, wherein the image is a background image for the graphical interface of the electronic game, wherein the graphical interface is a multi-layer graphical interface.

10. The method of claim 1, wherein the at least one graphical object comprises a video.

11. The method of claim 1, wherein the electronic game comprises one or more of the following: a game of skill, a brain fitness game, and a quiz game.

12. The method of claim 1, further comprising rewarding the user with virtual points for completing the electronic game.

13. The method of claim 12, wherein the rewarding is based on one or more of the following: game performance, user skill improvement, game level, and game score.

14. The method of claim 1, further comprising rewarding the user with one or more of the following: a social recognition title, a virtual badge, and a virtual emblem.

15. The method of claim 1, further comprising rewarding the user with one or more of the following: a financial discount, a free of charge product, and a free of charge service.

16. The method of claim 1, further comprising enabling the user to redeem the virtual points.

17. The method of claim 16, wherein the redeeming of the virtual points comprises providing to the user one or more of the following: a monetary reward, a non-monetary reward, virtual currency, a financial discount, a rebate, and at least a part of the product.

18. The method of claim 1, further comprising enabling the user to spend or transfer the virtual points to a third party, wherein the third party comprises one or more of the following: a merchant, a third party website, a social media site, a charity, and an online store.

19. The method of claim 1, further comprising aggregating advertisement campaign metrics.

20. The method of claim 19, wherein the advertisement campaign metrics comprise engagement metrics.

21. The method of claim 19, wherein the advertisement campaign metrics comprise brand lift metrics.

22. The method of claim 19, wherein the advertisement campaign metrics comprise cost-per-impression metrics or cost-per-engagement metrics.

23. The method of claim 19, wherein the advertisement campaign metrics comprise cost-per-action metrics.

24. The method of claim 19, wherein the advertisement campaign metrics comprise cost-per-play or cost-per-click metrics.

25. The method of claim 19, wherein the advertisement campaign metrics comprise gaming analytics and heat maps representing advertisement attention and interactivity metrics.

26. The method of claim 1, further comprising enabling advertisers to bid on desired advertisement placement and/or desired targeted audiences.

27. The method of claim 26, further comprising enabling the advertisers to select one or more targeting campaigns.

28. The method of claim 26, further comprising enabling the advertisers to select one or more third party websites and/or software applications to embed software widget, the software widget is configured to enable the user to play the electronic game via the third party website, wherein the software applications is configured to enable the user to play the electronic game.

29. The method of claim 1, further comprising prompting the user to play an additional electronic game or participate in a sweepstake, draw or a survey.

30. The method of claim 1, further comprising prompting the user to share, rate, recommend, save or bookmark the one or, more electronic games and/or one or more advertisement contents.

31. The method of claim 30, further comprising aggregating user shares, ratings, saved and bookmarked electronic games and/or advertisement contents for marketing research purposes.

32. The method of claim 31, further comprising generating one or more recommendations to suggest the user to play one or more electronic games, wherein the one or more recommendations are generated based upon advertisement campaign metrics and/or aggregated user shares, ratings, saved and bookmarked electronic games and/or advertisement contents.

33. The method of claim 1, further comprising prompting the user to make a purchase of a product or service.

34. The method of claim 1, further comprising generating one or more software widgets to be embedded into a third party website, the software widget is configured to enable the user to play the electronic game via the third party website.

35. The method of claim 1, further comprising generating Application Programming Interface (API) codes, the API codes are configured to enable the user to play the electronic game and/or track their gaming activity, performance, and collected virtual points via the third party website or a software application.

36. The method of claim 1, further comprising enabling users and/or advertisers to upload, generate, and edit the one or more graphical objects.

37. A system for advertising within an electronic game, the system comprising:
a communication module configured to receive a user request to initiate the electronic game for a user;
a graphical interface module configured to provide, in response to the user request, a graphical interface of the electronic game; and
an advertisement module configured to provide, within the graphical interface, one or more graphical objects representing advertisement content, wherein the one or more graphical objects constituting at least one subject of the electronic game or a background.

38. The system of claim 37, wherein the communication module is further configured to receive one or more inputs from the user, the one or more inputs represent actions performed by the user within the electronic game.

39. The system of claim 38, wherein the advertisement module is further configured to transform the one or more graphical objects, in response to the one or more inputs from the user.

40. The system of claim 38, wherein the one or more graphical objects are initially hidden, distorted, skewed, dispersed, or invisible to the user; and wherein the advertisement module is further configured to present, in response to the one or more inputs from the user, at least one part of the one or more graphical objects being previously initially hidden, distorted, skewed, dispersed, or invisible to the user.

41. The system of claim 38, wherein the advertisement module is further configured to provide, in response to the one or more inputs from the user, at least one additional graphical object representing the product.

42. The system of claim 37, further comprising a rewarding module configured to reward the user with virtual points for playing the electronic game.

43. The system of claim 37, further comprising an aggregation module configured to aggregate advertisement campaign metrics.

44. A processor-readable medium having instructions stored thereon, which when executed by one or more processors, cause the one or more processors to:
receive a user request to initiate the electronic game for a user;
provide, in response to the user request, a graphical interface of the electronic game; and
provide, within the graphical interface, one or more graphical objects representing advertising content, wherein the one or more graphical objects constituting at least one subject of the electronic game or a background.
